(19) United States
(12) Patent Application Publication
(10) Pub. No.: US 2021/0312347 A1
(43) Pub. Date: Oct. 7, 2021

(54) DISPATCHING DISTRIBUTION

(71) Applicant: Beijing Sankuai Online Technology Co., Ltd, Beijing (CN)

(72) Inventors: Jiehui BIAN, Beijing (CN); Tao ZHANG, Beijing (CN); Jinghua HAO, Beijing (CN); Bing KONG, Beijing (CN)

(21) Appl. No.: 17/266,624

(22) PCT Filed: Aug. 8, 2019
(86) PCT No.: PCT/CN2019/099714

§ 371 Date: Feb. 8, 2021

(30) Foreign Application Priority Data
Aug. 8, 2018 (CN) 201810899170.6

(51) Int. Cl. G06Q 10/04; G06Q 10/08; G06N 20/00; G06N 5/00

(52) U.S. Cl. CPC G06Q 10/047; G06Q 10/0838; G06N 5/003; G06N 20/00; G06Q 10/08355

(57) ABSTRACT

This application provides a method of dispatching the distribution. According to an example, the method of dispatching the distribution includes: planning, based on at least one combination of at least one target order and at least one target distributor, a distribution path of each target distributor after being assigned with a target order under each combination; calculating a distribution efficiency indicator and an order taking willingness indicator of the distribution path under each combination that are associated with the assignment of the target order to the target distributor; and selecting, based on the distribution efficiency indicator and the order taking willingness indicator of each combination, an optimal combination from the at least one combination for dispatching the distribution.

### CROSS-REFERENCE TO RELATED APPLICATIONS

This application is a US National Stage of International Application No. PCT/CN2019/099714, filed Aug. 8, 2019, which claims priority to Chinese Patent Application No. 2018108991706, filed on Aug. 8, 2018, and entitled “A METHOD AND AN APPARATUS FOR DISPATCHING DISTRIBUTION”, which are incorporated by reference herein in their entireties.

### TECHNICAL FIELD

This application relates to dispatching distribution.

### BACKGROUND

In the related art, to improve the logistics and distribution efficiency, a dispatching system needs to optimize the matching of orders and distributor, so that an order pushed to the distributor conforms to the distributor's path situation as far as possible. Specifically, the dispatching system may generally dispatch orders according to a matching indicator after a target order is newly added to the distributor. The matching indicator may represent a matching degree between distribution paths before and after the target order is newly added to the distributor. When the matching indicator is greater than a threshold, it indicates that the target order and a target distributor relatively match each other.

However, the dispatching distribution manner ignores the influence of distributor' subjective factors on the distribution relationship. For example, if a distributor's willingness to take the target order is not high, the distributor may also reject to take the order even if the matching indicator meets the requirements. Therefore, a real distribution relationship cannot be established and the dispatching accuracy and efficiency are affected.

### SUMMARY

According to a first aspect, this application provides a method of dispatching distribution. The method of dispatching distribution includes: planning, based on at least one combination of at least one target order and at least one target distributor, a distribution path of each target distributor after being assigned with a target order under each combination; calculating a distribution efficiency indicator and an order taking willingness indicator of the distribution path under each combination that are associated with the assignment of the target order to the target distributor; and selecting, based on the distribution efficiency indicator and the order taking willingness indicator of each combination, an optimal combination from the at least one combination for dispatching the distribution.

According to a second aspect, this application provides an apparatus for dispatching distribution. The apparatus for dispatching the distribution includes a path planning unit, a calculation unit, and a dispatching unit. The path planning unit is configured to plan, based on at least one combination of at least one target order and at least one target distributor, a distribution path of each target distributor after being assigned with a target order under each combination; The calculation unit is configured to calculate a distribution efficiency indicator and an order taking willingness indicator of the distribution path under each combination that are associated with the assignment of the target order to the target distributor; and the dispatching unit is configured to select, based on the distribution efficiency indicator and the order taking willingness indicator of each combination, an optimal combination from the at least one combination for dispatching distribution.

According to a third aspect, this application provides a computer-readable storage medium. The storage medium stores a computer program, and the computer program is configured to perform the method of dispatching the distribution described in the first aspect.

According to a fourth aspect, this application provides an electronic device. The electronic device includes a processor and a memory configured to store instructions executable by the processor. The processor is configured to perform the method of dispatching the distribution described in the first aspect.

In an embodiment of this application, a solution of dispatching distribution is provided. By calculating an order taking willingness indicator of a target distributor to an assigned target order and combining the order taking willingness indicator and a distribution efficiency indicator, a comprehensive indicator for a dispatching system's reference is obtained. The dispatching system determines whether to dispatch based on the comprehensive indicator. In this case, not only the objective factor like a distribution efficiency indicator is considered, but also the subjective factor like an order taking willingness of a distributor is considered. When a distributor is assigned with an order, because both a distribution efficiency indicator and an order taking willingness indicator conform to the requirements, the probability that the distributor accepts the order is effectively increased. Therefore, the dispatching accuracy and dispatching efficiency may be effectively improved.

### BRIEF DESCRIPTION OF THE DRAWINGS

FIG. 1 is a schematic structural diagram of a system of dispatching distribution according to an exemplary embodiment of this application.

FIG. 2 is a flowchart of a method of dispatching distribution according to an exemplary embodiment of this application.

FIG. 3 is a diagram of a hardware structure of an apparatus for dispatching distribution according to an exemplary embodiment of this application.

FIG. 4 is a schematic module diagram of an apparatus for dispatching distribution according to an exemplary embodiment of this application.

### DETAILED DESCRIPTION OF THE EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations that are consistent with this application. On the contrary, the implementations are merely examples of apparatuses and methods that are described in detail in the appended claims and that are consistent with some aspects of this application.

The terms used herein are for the purpose of describing specific embodiments only and are not intended to limit this application. The singular forms of “a” and “the” used in this application and the appended claims are intended to include the plural forms as well, unless the context clearly indicates otherwise. It should be further understood that the term “and/or” used herein indicates and includes any or all possible combinations of one or more associated listed items.

It should be understood that although the terms such as “first,” “second,” and “third,” may be used in this application to describe various information, the information should not be limited to these terms. These terms are merely used to distinguish between information of the same type. For example, without departing from the scope of this application, first information may also be referred to as second information, and similarly, second information may also be referred to as first information. Depending on the context, for example, the word “if” used herein may be interpreted as “while” or “when,” or “in response to determination.”

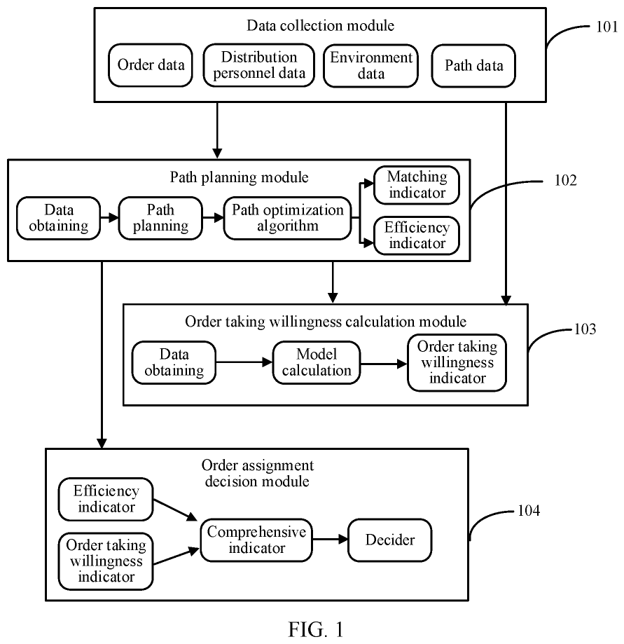

FIG. 1 is a schematic architectural diagram of a system of dispatching distribution according to an exemplary embodiment of this application. The dispatching system may include: a data collection module 101, a path planning module 102, an order taking willingness calculation module 103, and an order assignment decision module 104.

In an embodiment, data collected by the data collection module 101 includes 4 types of data, which are respectively order data, distributor data, environment data, and path data.

In an embodiment, the order data may include at least one of the following: a distribution distance, a distribution price, a distribution time period, a goods value, a goods-preparing time (a time from a creation time of the order to a time that the distributor can pick up), a latest delivery time, an order type (for example, an instant distribution type such as a takeaway and an express distribution), an area in which the order is located, a starting location (such as a merchant location), a destination location (such as a destination location of the order), or the like of the order.

In an embodiment, the distributor data may include distributor historical data and distributor real-time data.

The distributor historical data may include at least one of the following: a historical average speed, a historical average number of orders taken per day, a historical average order-refusing rate per day, an area to which has been delivered, a distribution applicant that has applied for distribution, historical order taken proportions of orders of different distribution distances, historical order taken proportions of orders of different distribution time periods, or historical order taken proportions of orders of different distribution prices.

The distributor real-time data may include at least one of the following: a distributor level or a distributor location.

In an embodiment, the environment data may include at least one of the following: weather of a current distribution area, a quantity of orders created within a preset time in a current distribution area, load data of the distributor within a preset time in a current distribution area, a quantity of idle distributors within a preset time in a current distribution area, or a cancel rate of assigned orders within a preset time in a current distribution area.

In an embodiment, the path data may include at least one of the following: a distance between a distributor and a starting location of each order and a time required for the distributor to go to the starting location; a distance between a distributor and a destination location of each order and a time required for the distributor to go to the destination location; a distance between starting locations of orders and a time required for traveling between the starting locations of the orders; a distance between destination locations of orders and a time required for traveling between the destination locations of the orders, or a distance between a starting location and a destination location of an order and a time required for traveling between the starting location and the destination location.

The data collection module 101 may convert the collected original data into a data format that can be directly used by the path planning module 102 and the order taking willingness calculation module 103 subsequently. Generally, data from different sources usually cannot be directly used by a system due to different data formats, for example, some data is structured data (for example, database data), and some data is unstructured data (for example, office documents of various formats, XML, HTML, report, picture, and audio and video). The data collection module 101 may convert all the collected data into standardized data in a uniform format, so as to be convenient for other modules to use directly.

In an embodiment, the path planning module 102 is configured to plan a distribution path of a distributor, and calculate a matching degree and an efficiency indicator based on the distribution path. As shown in FIG. 1, the distributor data, the order data, the environment data, the path data, and the like collected by the data collection module 101 are required to plan the distribution path, and therefore, a corresponding distribution path is planned based on data such as a distributor location and speed, a starting location and destination location of an order, a distribution area environment, and a distribution area path. Further, an optimal distribution path may be planned based on the path optimization algorithm, and therefore an optimal matching indicator and efficiency indicator are calculated. The matching indicator indicates a degree of similarity between distribution paths of the target distributor before and after being assigned with the target order, and the efficiency indicator indicates an efficiency level of the target distributor distributing the target order.

An objective of the path optimization algorithm comprises planning a distribution path with shortest distribution time after the target distributor is assigned with the target order.

For example, if a logistics order i and a distributor j are obtained, and the distributor j already has 5 to-be-distributed orders, and 2 of which are picked up and 3 of which are not picked up. In this case, the distributor j has 8 destinations in total, that is, 3 starting locations (corresponding to the 3 orders that are not picked up) and 5 destination locations. Different sequences of reaching the starting locations and the destination locations of the orders may have different distribution paths, and directly affect a final distribution time. Therefore, the distribution path needs to be optimized, to obtain shortest total distribution time.

It is to be noted that, to adapt to a service logic limit, the optimization algorithm needs to have at least one constraint condition as follows.

1. A target distributor, when distributing a target order, needs to go to a starting location of the target order first, and then go to a destination location of the target order. In an actual logistics and distribution, necessarily, a complete distribution process of an order is that, a distributor first goes to a starting location of the order to pick up the goods, and then carries the taken goods to a destination location of the order.

2. A total quantity of orders of a target distributor after being assigned with a target order is less than or equal to a maximum quantity of orders taken. In an actual logistics and distribution, there is a maximum quantity of orders taken that each distributor can distribute. If a distributor takes excessive orders at the same time, the timeliness of each order cannot be ensured. Generally, having excessive orders means that some orders inevitably have the problem of distribution timeout, and therefore, a maximum quantity of orders taken by a distributor may be set. A quantity of orders of a distributor after being assigned with a target order is less than or equal to a maximum quantity of orders taken. The maximum quantity of orders taken may be set by a system, or may be set by a distributor according to an actual situation of its own.

3. After a target distributor is assigned with a target order, all currently-uncompleted orders and the target order are completed before a latest delivery time. In an actual logistics and distribution, after each order is created, there is a corresponding latest delivery time indicating a latest delivery time that the distribution receiver can accept. If an actual delivery time is later than the latest delivery time, it is a distribution timeout. When a single order is distributed, generally, an estimated delivery time is earlier than a latest delivery time. However, when a plurality of orders are distributed at the same time, because distribution paths are increased, an estimated delivery time of each order changes accordingly. When a dispatching system dispatches, an estimated delivery time of each order in a planned distribution path needs to be ensured not to be later than a latest delivery time.

4. A difference between a goods-preparing time of the target order and a time required for the target distributor to go to a starting location of the target order is less than a threshold. In an actual logistics and distribution, goods-preparing times of different distribution applicants are different. If a distributor arrives at a starting location too early, it does not mean that the goods can be picked up now. If a distribution applicant still prepares the goods, a distributor needs to wait. In this case, valuable distribution time is wasted. Therefore, it needs to be ensured that when arriving at the starting location, the distributor can pick up the goods right now or as soon as possible. In this case, a difference between the goods-preparing time of the order and a time required for a target distributor to go to the starting location of the order is less than the threshold, it indicates that the goods may be prepared by the distribution applicant before the arriving of the distributor or in a short period after the arriving of the distributor, so that the distributor can quickly complete the pick-up.

Herein, the path optimization algorithm may include a simulated annealing algorithm, an ant colony algorithm, a particle swarm optimization, and the like.

In an embodiment, the order taking willingness calculation module 103 is configured to calculate an order taking willingness indicator of a distributor to an assigned order. The order taking willingness indicator indicates a degree to which the distributor accepts the order. Specifically, the order taking willingness calculation module 103 may calculate the order taking willingness indicator based on a machine learning model, according to the order data, the distributor data, and the environment data obtained by the data collection module 101, and according to the matching indicator obtained by the path planning module 102.

The order taking willingness model is obtained through training by using the following manners: performing model training based on a machine learning algorithm by using basic data and matching indicators of historical orders as training data and using whether a distributor accepts or rejects the historical order when assigned with the historical order as labels, and obtaining a trained model as the order taking willingness model.

The machine learning algorithm may include at least one of an xgboost, a logistic regression, a random forest, a decision tree, a gradient boost decision tree (GBDT), or a support vector machine.

In an embodiment, the order assignment decision module 104 may calculate a comprehensive indicator according to the efficiency indicator and the order taking willingness indicator, and then the order assignment decision module 104 determines whether to dispatch in a corresponding combination according to the comprehensive indicator. In an example, the order assignment decision module 104 is a decider.

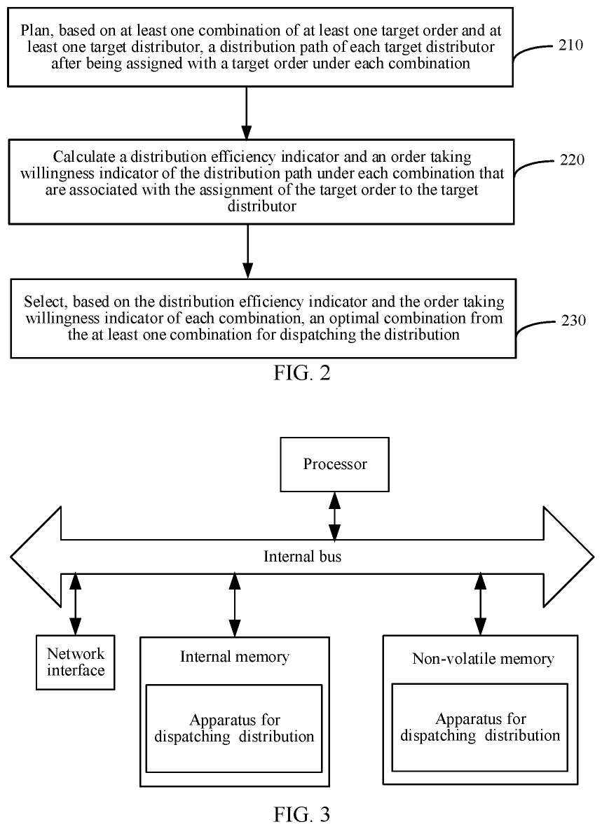

FIG. 2 is a flowchart of a method of dispatching distribution according to an exemplary embodiment of this application. The method may be applied to the dispatching system, and the method may specifically include the following steps 210 to step 230.

Step 210. Plan, based on at least one combination of at least one target order and at least one target distributor, a distribution path of each target distributor after being assigned with a target order under each combination.

In an example, the dispatching system may obtain at least one combination, and the at least one combination includes at least one to-be-assigned target order and at least one target distributor. As described above, a distributor may distribute a plurality of orders at the same time, and the distributor has a maximum quantity of orders taken. A target distributor is the foregoing idle distributor, may be a distributor whose quantity of orders taken at the same time does not reach a maximum quantity of orders taken.

Then, the dispatching system may plan a distribution path of the target distributor after being assigned with the target order under the combination. Step 210 may be performed by the path planning module in the dispatching system.

In an embodiment, the planning a distribution path of each target distributor after being assigned with a target order under each combination specifically includes: planning an optimal distribution path of the target distributor after being assigned with the target order under each combination.

In an embodiment, the optimal distribution path may be a distribution path requiring shortest distribution time after the target distributor is assigned with the target order.

Further, the planning an optimal distribution path of the target distributor after being assigned with the target order under each combination specifically includes: planning, based on a path optimization algorithm, the optimal distribution path of the target distributor after being assigned with the target order under each combination.

An objective of the path optimization algorithm comprises planning a distribution path with shortest distribution time after the target distributor is assigned with the target order.

A constraint condition of the path optimization algorithm includes at least one of the following:

a target distributor, when distributing a target order, needs to go to a starting location of the target order first, and then go to a destination location of the target order;

a total quantity of orders of a target distributor after being assigned with a target order is less than or equal to a maximum quantity of orders taken;

after a target distributor is assigned with a target order, all currently-uncompleted orders and the target order are completed before a latest delivery time; or

a difference between a goods-preparing time of the target order and a time required for the target distributor to go to a starting location of the target order is less than a first threshold.

Step 220. Calculate a distribution efficiency indicator and an order taking willingness indicator of the distribution path under each combination that are associated with the assignment of the target order to the target distributor.

In an embodiment, the distribution efficiency indicator may include a matching indicator and an efficiency indicator.

In an embodiment, step 220 may specifically include the following step B1 and step B2.

Step B1. Calculate a matching indicator and an efficiency indicator of the distribution path under each combination, where the matching indicator indicates a degree of similarity between distribution paths of the target distributor before and after being assigned with the target order, and the efficiency indicator indicates an efficiency level of the target distributor distributing the target order.

Step B2. Calculate, according to the matching indicator of each combination, the order taking willingness indicator of the target distributor under each combination, where the order taking willingness indicator indicates a degree to which the target distributor accepts the target order.

Step B1 may be performed by the path planning module in the dispatching system.

In an example, the matching indicator may be a value between 0 and 1. When the value is closer to 1, it indicates that the degree of similarity is higher. Otherwise, when the value is closer to 0, it indicates that the degree of similarity is lower.

In an example, the efficiency indicator may be a value between 0 and 1. When the value is closer to 1, it indicates that the efficiency of the target distributor distributing the target order is higher. Otherwise, when the value is closer to 0, it indicates that the efficiency of the target distributor distributing the target order is lower. Generally, if a starting location or a destination location of a target order is relatively close to a starting location or a destination location of another order of the target distributor, the efficiency is relatively high.

Step B2 may be performed by the order taking willingness calculation module in the dispatching system.

In an embodiment, step B2 may specifically include: obtaining basic data of a target order under each combination; and inputting the basic data and the matching indicator into an order taking willingness model, and obtaining the order taking willingness indicator of the target distributor under each combination that is calculated by the order taking willingness model.

In an embodiment, the obtaining basic data of a target order under each combination specifically includes: obtaining order taken proportions of different types of orders from historical order taken data of the target distributor under each combination; determining the order taken proportion of a type to which the target order belongs in the historical order taken data; and using the determined order taken proportion as the basic data of the target order.

In an embodiment, the different types include at least one of the following: different distribution distances, different distribution time periods, different distribution prices, or different distribution areas.

For example, order taken proportions of different distribution distances are obtained from historical data of the target distributor, and an order taken proportion of the target order is determined in combination with the distribution distance of the target order. The order taken proportion may reflect a preference of the target distributor to an order of the distribution distance.

In another example, order taken proportions of different distribution time periods are obtained from historical data of the target distributor, and an order taken proportion of the target order is determined in combination with the distribution time period of the target order. The order taken proportion may reflect a preference of the target distributor to an order of the distribution time period.

In another example, order taken proportions of different distribution prices are obtained from historical data of the target distributor, and an order taken proportion of the target order is determined in combination with the distribution price of the target order. The order taken proportion may reflect a preference of the target distributor to an order of the distribution price.

In another example, order taken proportions of different distribution areas are obtained from historical data of the target distributor, and an order taken proportion of the target order is determined in combination with the distribution area of the target order. The order taken proportion may reflect a preference of the target distributor to an order of the distribution area. It is worth mentioning that, areas to which the distributor has distributed may be encoded by using a geohash algorithm. These areas are divided into isometric blocks according to latitude and longitude, and the historical distribution times of target distributor in different blocks is counted. Similarly, target blocks in which a geographic location of a distribution applicant of a target order and/or a geographic location of a distribution receiver are located may be determined according to the geohash algorithm. A historical distribution times of the target area is obtained from the counted historical distribution times on different blocks.

In an embodiment, the order taking willingness model is obtained through training by using the following manners: performing model training based on a machine learning algorithm by using basic data and matching indicators of historical orders as training data and using whether a distributor accepts or rejects the historical order when assigned with the historical order as labels, and obtaining a trained model as the order taking willingness model.

The machine learning algorithm includes at least one of an xgboost, a logistic regression, a random forest, a decision tree, a GBDT, or a support vector machine.

Step 230. Select, based on the distribution efficiency indicator and the order taking willingness indicator of each combination, an optimal combination from the at least one combination for dispatching the distribution.

In this embodiment, the dispatching system may select, based on the distribution efficiency indicator and the order taking willingness indicator of each combination, an optimal combination for dispatching the distribution from all the combinations. The step may be performed by the order assignment decision module in the dispatching system.

In an embodiment, step 230 may specifically include the following step A1 and step A2.

Step A1. Calculate, according to the distribution efficiency indicator and the order taking willingness indicator of each combination, a comprehensive indicator of each combination.

Step A2. Select, according to the comprehensive indicator of each combination, an optimal combination for dispatching the distribution from all the combinations.

Step A1 and step A2 may be performed by the order assignment decision module in the dispatching system.

In an embodiment, step A1 specifically includes: multiplying the distribution efficiency indicator of each combination by an efficiency weight, to obtain an efficiency value; multiplying the order taking willingness indicator of each combination by a willingness weight, to obtain a willingness value; and summing the efficiency value and the willingness value of each combination, to obtain the comprehensive indicator corresponding to each combination, where a sum of the efficiency weight and the willingness weight is 1.

As described above, the distribution efficiency indicator includes a matching indicator and an efficiency indicator. Therefore, in this embodiment, the efficiency value may be specifically the efficiency value obtained by multiplying the efficiency indicator in the distribution efficiency indicator by the efficiency weight.

In an embodiment, in a case that there is 1 target order, 1 target distributor, and 1 combination, step A2 specifically includes: dispatching the distribution according to the combination in a case that the comprehensive indicator of the 1 combination is greater than a second threshold.

In an embodiment, where in a case that there is 1 target order, N target distributors, and N combinations, N being a natural number greater than 1, step A2 specifically includes: selecting a maximum comprehensive indicator from the N comprehensive indicators, and dispatching the distribution according to a combination corresponding to the maximum comprehensive indicator.

In an embodiment, where in a case that there are M target orders, N target distributors, and M*N combinations, M and N being natural numbers greater than 1, step A2 specifically includes: selecting one comprehensive indicator from each row of M rows*N columns of the comprehensive indicators based on a decision algorithm, to enable a sum of M comprehensive indicators to be maximum, where target orders of combinations corresponding to the selected M comprehensive indicators are non-repetitive; and dispatching the distribution according to the combinations corresponding to the selected M comprehensive indicators.

For example, if there are M target orders and N target distributors, correspondingly, there are M*N different types of combinations. Similarly, there may alternatively be M*N efficiency indicators and order taking willingness indicators. It is assumed that an efficiency indicator of an i^{th} distributor to a j^{th} order is eᵢⱼ, and an order taking willingness indicator of the i^{th} distributor to the j^{th} order is wᵢⱼ. Therefore, the M orders and the N distributors may establish a matrix with M rows and N columns, and a value of row i and column j in this matrix is a value of a comprehensive indicator, which is recorded as pᵢⱼ.

In this application, pᵢⱼ=λ*wᵢⱼ+(1−λ)*eᵢⱼ, where λ may represent an efficiency weight, and the efficiency weight may be an empirical value preset artificially, and 1−λ may represent a willingness weight correspondingly. An objective of the order assignment decision module is to assign each order to a most suitable distributor, so that a sum of each p of each order (M orders) is the largest. The constraint condition herein is that each order can only be assigned to one distributor, and each distributor has a maximum quantity of orders taken. The solution of the foregoing formula is similar to the bipartite graph most authority perfect matching manner, and a decision algorithm such as a KM algorithm or a hungary algorithm may be adopted.

In an embodiment of this application, a method of dispatching the distribution is provided. By calculating an order taking willingness indicator of a target distributor to an assigned target order and combining the order taking willingness indicator and a distribution efficiency indicator, a comprehensive indicator for a dispatching system's reference is obtained. The dispatching system determines whether to dispatch based on the comprehensive indicator. In this case, not only the objective factor like a distribution efficiency indicator is considered, but also the subjective factor like an order taking willingness of a distributor is considered. When a distributor is assigned with an order, because both a distribution efficiency indicator and an order taking willingness indicator conform to the requirements, the probability that the distributor accepts the order is effectively increased. Therefore, the dispatching accuracy and dispatching efficiency may be effectively improved.

With the continuous growth of logistics and distribution service, the existing logistics and distribution resources are increasingly unable to meet the demand for even distribution. For example, the number of teams of professional distributors is limited, and the demand for distribution is increasing. The limited number of distributors is far from enough to meet the daily distribution demand, resulting in backlogs and delays of distribution orders. In a case that a quantity of full-time distributors cannot grow rapidly, a new mode of logistics and distribution emerges by mobilizing social idle labor to participate in the logistics and distribution service. For example, an online to offline (O2O) crowdsourcing model. Different from the traditional logistics and distribution based on full-time distributors, these part-time distributors usually take orders only when they are on the way, and are often reluctant to take orders when they are not on the way. Therefore, in the O2O crowdsourcing model, the part-time distributors can choose to accept or reject assigned logistics orders. The solution of dispatching the distribution according to this application is not only applied to the traditional full-time distributors model, but also applied to the O2O crowdsourcing model. The distribution is dispatched by combining a distribution efficiency indicator of a distribution path and an order taking willingness of a part-time distributor, and therefore, the probability that a part-time distributor accepts an assigned order is greatly increased, thereby effectively improving the dispatching accuracy and dispatching efficiency.

This application provides an embodiment of an apparatus for dispatching the distribution. The apparatus embodiment may be applied to a server. The device embodiments may be implemented by using software, or hardware or in a manner of a combination of software and hardware. Taking software implementation as an example, an apparatus in a logical aspect is formed by a processor in which the apparatus resides reading corresponding computer program instructions in a non-volatile memory into an internal memory for running. On a hardware level, FIG. 3 is a hardware structural diagram in which an apparatus for dispatching the distribution according to this application is located, in addition to a processor, an internal memory, a network interface, and a non-volatile memory shown in FIG. 3, the embodiment may usually further include other hardware according to actual functions of dispatching distribution. Details will not be repeated herein.

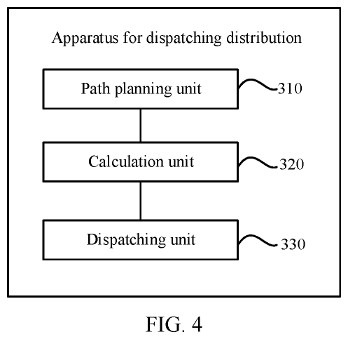

Referring to FIG. 4, in a software implementation, the apparatus for dispatching distribution may include: a path planning unit 310, a calculation unit 320, and a dispatching unit 330.

The path planning unit 310 is configured to plan, based on at least one combination of at least one target order and at least one target distributor, a distribution path of each target distributor after being assigned with a target order under each combination.

The calculation unit 320 is configured to calculate a distribution efficiency indicator and an order taking willingness indicator of the distribution path under each combination that are associated with the assignment of the target order to the target distributor.

The dispatching unit 330 is configured to select, based on the distribution efficiency indicator and the order taking willingness indicator of each combination, an optimal combination from the at least one combination for dispatching distribution.

In some embodiments, the calculation unit 320 specifically includes: a first calculation subunit and a second calculation subunit.

The first calculation subunit is configured to calculate a matching indicator and an efficiency indicator of the distribution path under each combination, where the matching indicator indicates a degree of similarity between distribution paths of the target distributor before and after being assigned with the target order, and the efficiency indicator indicates an efficiency level of the target distributor distributing the target order.

The second calculation subunit is configured to calculate, according to the matching indicator of each combination, the order taking willingness indicator of the target distributor under each combination, where the order taking willingness indicator indicates a degree to which the target distributor accepts the target order.

In some embodiments, the path planning unit 310 specifically includes: an obtaining subunit and a path planning subunit.

The obtaining subunit is configured to obtain at least one combination of at least one to-be-assigned target order and at least one target distributor.

The path planning subunit is configured to plan an optimal distribution path of the target distributor after being assigned with the target order under each combination.

In some embodiments, the path planning subunit is specifically configured to plan, based on a path optimization algorithm, the optimal distribution path of the target distributor after being assigned with the target order under each combination.

In some embodiments, an objective of the path optimization algorithm comprises planning a distribution path with shortest distribution time after the target distributor is assigned with the target order.

In some embodiments, a constraint condition of the path optimization algorithm includes at least one of the following:

a target distributor, when distributing a target order, needs to go to a starting location of the target order first, and then go to a destination location of the target order;

a total quantity of orders of a target distributor after being assigned with a target order is less than or equal to a maximum quantity of orders taken;

after a target distributor is assigned with a target order, all currently-uncompleted orders and the target order are completed before a latest delivery time; or

a difference between a goods-preparing time of the target order and a time required for the target distributor to go to a starting location of the target order is less than a first threshold.

The optimization algorithm includes at least one of a simulated annealing algorithm, an ant colony algorithm, and a particle swarm optimization.

In some embodiments, the second calculation subunit specifically includes: an obtaining subunit and a calculation subunit.

The obtaining subunit is configured to obtain basic data of a target order under each combination.

The calculation subunit is configured to input the basic data and the matching indicator into an order taking willingness model, and obtain the order taking willingness indicator corresponding to the target distributor that is calculated by the order taking willingness model.

In some embodiments, the obtaining subunit specifically includes: a proportion obtaining subunit, a proportion determining subunit, and a data determining subunit.

The proportion obtaining subunit is configured to obtain order taken proportions of different types of orders from historical order taken data of the target distributor under each combination.

The proportion determining subunit is configured to determine the order taken proportion of a type to which the target order belongs in the historical order taken data.

The data determining subunit is configured to use the determined order taken proportion as the basic data of the target order.

In some embodiments, the different types include: at least one of different distribution distances, different distribution time periods, different distribution prices, or different distribution areas.

In some embodiments, the order taking willingness model is obtained through training by using the following manners: performing model training based on a machine learning algorithm by using basic data and matching indicators of historical orders as training data and using whether a distributor accepts or rejects the historical order when assigned with the historical order as labels, and obtaining a trained model as the order taking willingness model.

In some embodiments, the machine learning algorithm includes at least one of an xgboost, a logistic regression, a random forest, a decision tree, a GBDT, or a support vector machine.

In some embodiments, the dispatching unit 330 specifically includes: a first dispatching subunit and a second dispatching subunit.

The first dispatching subunit is configured to calculate, according to the distribution efficiency indicator and the order taking willingness indicator of each combination, a comprehensive indicator of each combination.

The second dispatching subunit is configured to select, according to the comprehensive indicator of each combination, the optimal combination from the at least one combination for dispatching distribution.

In some embodiments, the first dispatching subunit specifically includes: a first calculation subunit, a second calculation subunit, and a third calculation subunit.

The first calculation subunit is configured to multiply the distribution efficiency indicator of each combination by an efficiency weight, to obtain an efficiency value.

The second calculation subunit is configured to multiply the order taking willingness indicator of each combination by a willingness weight, to obtain a willingness value.

The third calculation subunit is configured to sum the efficiency value and the willingness value of each combination, to obtain the comprehensive indicator corresponding to each combination, where a sum of the efficiency weight and the willingness weight is 1.

In some embodiments, in a case that there is 1 target order, 1 target distributor, and 1 combination, the second dispatching subunit is specifically configured to dispatch according to the 1 combination in a case that the comprehensive indicator is greater than a second threshold.

In some embodiments, in a case that there is 1 target order, N target distributors, and N combinations, N being a natural number greater than 1, the second dispatching subunit is specifically configured to select a maximum comprehensive indicator from the N comprehensive indicators and dispatching the distribution according to a combination corresponding to the maximum comprehensive indicator.

In some embodiments, in a case that there are M to-be-assigned target orders, N idle target distributors, and M*N combinations, M and N being natural numbers greater than 1, the second dispatching subunit includes a selecting subunit and a dispatching subunit.

The selecting subunit is configured to select one comprehensive indicator from each row of M rows*N columns of the comprehensive indicators based on a decision algorithm, to enable a sum of M comprehensive indicators to be maximum, where target orders of combinations corresponding to the selected M comprehensive indicators are non-repetitive; and

The dispatching subunit is configured to dispatching the distribution according to the combinations corresponding to the selected M comprehensive indicators.

In some embodiments, the decision algorithm includes at least one of KM algorithm or a hungary algorithm.

Reference to the implementation processes of corresponding steps in the foregoing method may be made for details of the implementation processes of the functions and effects of the units in the apparatus. Details are not described herein again.

Because the apparatus embodiments basically correspond to the method embodiments, for related parts, reference may be made to the descriptions in the method embodiments. The foregoing described device embodiments are merely examples. The units described as separate parts may or may not be physically separate, and the parts displayed as units may or may not be physical units, may be located in one position, or may be distributed on a plurality of network units. Some of or all of the modules may be selected according to actual needs for achieving the objectives of the solutions of this application. A person of ordinary skill in the art may understand and implement the embodiments without creative efforts.

An embodiment of this application provides a computer-readable storage medium, where the storage medium stores a computer program, and the computer program is configured to perform any one of the foregoing method embodiments of dispatching the distribution.

An embodiment further provides an electronic device. As shown in FIG. 3, the electronic device includes a processor and a memory. For example, the memory includes an internal memory and a non-volatile memory. The memory is configured to store instructions executable by the processor. The processor is configured to perform any one of the foregoing method embodiments of dispatching the distribution.

Various embodiments herein are all described in a progressive manner, for same or similar parts in the embodiments, refer to such embodiments, and descriptions of each embodiment focus on a difference from other embodiments. Especially, an electronic device embodiment is basically similar to a method embodiment, and therefore is described briefly; for related parts, reference may be made to partial descriptions in the method embodiment.

The foregoing descriptions are merely exemplary embodiments of this application, but are not intended to limit this application. Any modification, equivalent replacement, improvement, or the like made without departing from the spirit and principle of this application shall fall within the protection scope of this application.

1. A method of dispatching distribution, comprising:
planning, based on at least one combination of at least one target order and at least one target distributor, a distribution path of each target distributor after being assigned with a target order under each combination;
calculating a distribution efficiency indicator and an order taking willingness indicator of the distribution path under each combination that are associated with the assignment of the target order to the target distributor; and
selecting, based on the distribution efficiency indicator and the order taking willingness indicator of each combination, an optimal combination from the at least one combination for dispatching the distribution.

2. The method according to claim 1, wherein
the distribution efficiency indicator comprises a matching indicator and an efficiency indicator, and, wherein
calculating the distribution efficiency indicator and the order taking willingness indicator of the distribution path under each combination that are associated with the assignment of the target order to the target distributor comprises:
calculating a matching indicator and an efficiency indicator of the distribution path under each combination, wherein the matching indicator indicates a degree of similarity between distribution paths of the target distributor before and after being assigned with the target order, and the efficiency indicator indicates an efficiency level of the target distributor distributing the target order; and
calculating, according to the matching indicator of each combination, the order taking willingness indicator of the target distributor under each combination, wherein the order taking willingness indicator indicates a degree to which the target distributor accepts the target order.

3. The method according to claim 1, wherein planning the distribution path of each target distributor after being assigned with a target order under each combination comprises:
planning an optimal distribution path of the target distributor after being assigned with the target order under each combination.

4. The method according to claim 3, wherein planning the optimal distribution path of the target distributor after being assigned with the target order under each combination comprises:
planning, based on a path optimization algorithm, the optimal distribution path of the target distributor after being assigned with the target order under each combination.

5. The method according to claim 4, wherein an objective of the path optimization algorithm comprises planning a distribution path with shortest distribution time after the target distributor is assigned with the target order.

6. The method according to claim 4, wherein a constraint condition of the path optimization algorithm comprises at least one of:
a target distributor, when distributing a target order, goes to a starting location of the target order first, and then goes to a destination location of the target order;
a total quantity of orders of a target distributor after being assigned with a target order is less than or equal to a maximum quantity of orders taken;
after a target distributor is assigned with a target order, both currently-uncompleted orders and the target order are completed before a latest delivery time; or
a difference between a goods-preparing time of the target order and a time required for the target distributor to go to a starting location of the target order is less than a first threshold.

7. The method according to claim 4, wherein the optimization algorithm comprises at least one of a simulated annealing algorithm, an ant colony algorithm, or a particle swarm optimization.

8. The method according to claim 2, wherein calculating, according to the matching indicator of each combination, the order taking willingness indicator of the target distributor under each combination comprises:
obtaining basic data of a target order under each combination; and
inputting the basic data and the matching indicator into an order taking willingness model, and obtaining the order taking willingness indicator of the target distributor under each combination that is calculated by the order taking willingness model.

9. The method according to claim 8, wherein obtaining the basic data of the target order under each combination comprises:
obtaining order taken proportions of different types of orders from historical order taken data of the target distributor under each combination;
determining the order taken proportion of a type to which the target order belongs in the historical order taken data; and
taking the determined order taken proportion as the basic data of the target order.

10. The method according to claim 9, the different types comprise at least one of:
different distribution distances, different distribution time periods, different distribution prices, or different distribution areas.

11. The method according to claim 8, wherein the order taking willingness model is obtained through training in the following manner:
performing model training based on a machine learning algorithm by using basic data and matching indicators of historical orders as training data and using whether a distributor accepts or rejects the historical order when assigned with the historical order as labels, and obtaining a trained model as the order taking willingness model.

12. The method according to claim 11, wherein the machine learning algorithm comprises at least one of an xgboost, a logistic regression, a random forest, a decision tree, a gradient boost decision tree, or a support vector machine.

13. The method according to claim 1, wherein the selecting, based on the distribution efficiency indicator and the order taking willingness indicator of each combination, an optimal combination from the at least one combination for dispatching the distribution comprises:
calculating, according to the distribution efficiency indicator and the order taking willingness indicator of each combination, a comprehensive indicator of each combination; and
selecting, according to the comprehensive indicator of each combination, the optimal combination from the at least one combination for dispatching the distribution.

14. The method according to claim 13, wherein calculating, according to the distribution the efficiency indicator and the order taking willingness indicator of each combination, a comprehensive indicator of each combination comprises:
obtaining an efficiency value by multiplying the distribution efficiency indicator of each combination by an efficiency weight;
obtaining a willingness value by multiplying the order taking willingness indicator of each combination by a willingness weight; and
obtaining the comprehensive indicator corresponding to each combination by summing the efficiency value and the willingness value of each combination, wherein a sum of the efficiency weight and the willingness weight is 1.

15. The method according to claim 13, wherein in a case that there is one target order, one target distributor, and one combination,
the selecting, according to the comprehensive indicator of each combination, the optimal combination from the at least one combination for dispatching distribution comprises:
dispatching the distribution according to the one combination when the comprehensive indicator of the one combination is greater than a second threshold.

16. The method according to claim 13, wherein in a case that there is one target order, N target distributors, and N combinations, where N is a natural number greater than 1,
selecting, according to the comprehensive indicator of each combination, the optimal combination from the at least one combination for dispatching the distribution comprises:
selecting a maximum comprehensive indicator from the N comprehensive indicators, and dispatching the distribution according to a combination corresponding to the maximum comprehensive indicator.

17. The method according to claim 13, wherein in a case that there are M target orders, N target distributors, and M*N combinations, where M and N are natural numbers greater than 1 respectively,
selecting, according to the comprehensive indicator of each combination, the optimal combination from the at least one combination for dispatching the distribution comprises:
selecting one comprehensive indicator from each row of M rows*N columns of the comprehensive indicators based on a decision algorithm, to enable a sum of M comprehensive indicators to be maximum, wherein target orders of combinations corresponding to the selected M comprehensive indicators are non-repetitive; and
dispatching the distribution according to the combinations corresponding to the selected M comprehensive indicators.

18. The method according to claim 17, wherein the decision algorithm comprises at least one of KM algorithm or a hungary algorithm.

19. (canceled)

20. A computer-readable storage medium, wherein the storage medium stores a computer program, and the computer program is configured to perform:
planning, based on at least one combination of at least one target order and at least one target distributor, a distribution path of each target distributor after being assigned with a target order under each combination;
calculating a distribution efficiency indicator and an order taking willingness indicator of the distribution path under each combination that are associated with the assignment of the target order to the target distributor; and
selecting, based on the distribution efficiency indicator and the order taking willingness indicator of each combination, an optimal combination from the at least one combination for dispatching the distribution.

21. An electronic device, comprising:
a processor; and
a memory, configured to store instructions executable by the processor, wherein
the processor is configured to:
plan, based on at least one combination of at least one target order and at least one target distributor, a distribution path of each target distributor after being assigned with a target order under each combination;
calculate a distribution efficiency indicator and an order taking willingness indicator of the distribution path under each combination that are associated with the assignment of the target order to the target distributor; and
select, based on the distribution efficiency indicator and the order taking willingness indicator of each combination, an optimal combination from the at least one combination for dispatching the distribution.
